(19) United States
(12) Patent Application Publication
(10) Pub. No.: US 2013/0163581 A1
(43) Pub. Date: Jun. 27, 2013

(54) SYSTEMS AND METHODS OF INTEGRATING CALL DETAIL RECORD INFORMATION FROM MULTIPLE SOURCES

(71) Applicants: Casem Majd, Holmdel, NJ (US); Paul Beyer, Holmdel, NJ (US); Andrew Bucko, Old Bridge, NJ (US); Rohan Dwarkha, Mendham, NJ (US); Nirav J. Kadakia, Parlin, NJ (US); Stephen Vansaders, Manalapan, NJ (US)

(72) Inventors: Casem Majd, Holmdel, NJ (US); Paul Beyer, Holmdel, NJ (US); Andrew Bucko, Old Bridge, NJ (US); Rohan Dwarkha, Mendham, NJ (US); Nirav J. Kadakia, Parlin, NJ (US); Stephen Vansaders, Manalapan, NJ (US)

(21) Appl. No.: 13/335,108

(22) Filed: Dec. 22, 2011

(51) Int. Cl. H04L 12/66

(52) U.S. Cl. 370/352

(57) ABSTRACT

A system for establishing Internet protocol based telephony communications between a calling telephony device and a called telephony device includes multiple logical elements that help to setup and carry the telephony communication. Multiple ones of the logical elements create call detail records that contain data about the telephony communication. Information contained in the call detail records is used to determine which call detail records relate to the same telephony communication. Once the call detail records relating to the same telephony communication are identified, a global identification number can be written into each of the call detail records to tie them together, or information drawn from the multiple call detail records can be used to create a single consolidated call detail record.

### BACKGROUND OF THE INVENTION

The invention is related to Internet Protocol (IP) telephony systems. More specifically, the invention is related to systems and methods for recording information about calls that are routed over IP telephony systems.

Existing IP telephony systems allow users to place and receive telephone calls or to send and/or receive other types of communications, such as text messages, SMS messages, MMS messages and the like. The communications are transmitted, at least in part, by data packets that traverse a private and/or public data network.

For example, a calling party can place a telephone call to a called party using an IP telephony device that is coupled to a private or public data network. When the user requests that the call be placed, an IP telephony system receives the request and sets up the call between the calling party's telephony device and the called party's telephony device. The called party's telephony device can also be an IP telephony device that is coupled to a private or public data network. Alternatively, the called party's telephony device could be an analog telephone that is coupled to a publically switched telephony network (PSTN). In still other instances, the called party's telephony device could be a cellular telephone or a mobile computing device with cellular telephone capabilities that is coupled to a cellular telephony network.

When an IP based telephony communication is established between the calling party's telephony device and the called party's telephony device, it is necessary to record information about that communication so that the appropriate parties can be billed for the communication. For example, the calling party may be charged a per minute rate if the call is a long distance call, a call to a different country, or a special toll bearing call. In those instances, it is necessary to record the called party's telephone number and/or the location to which the call was routed, and the duration of the call. This recorded information is then used to calculate the appropriate charges to be billed to the calling party.

Also, the IP telephony system may need to pay a third party to complete the call to the called party's telephony device. In that instance, it is desirable for the IP telephony system to track various items of information about the call so that the IP telephony system can verify that it is being charged the proper amount by the third party.

Typically, the IP telephony system will create one or more call detail records (CDRs) for each call or other telephony communication that is carried over the IP telephony system. The CDRs are stored in databases that can be used to generate bills for its own customers, or to verify that charges applied by third party service providers are accurate and appropriate.

If only a single CDR is created for each telephony communication, it is relatively easy to track the information in a CDR database. However, when a modern IP telephony system receives a call setup request from a calling party's telephony device, it is common for multiple logical elements within the IP telephony system to work together to determine how to setup the communication, and how the data packets bearing the communication should be routed. In many instances multiple ones of those logical elements each create their own CDR bearing information about the telephony communication. When this occurs, it is common for multiple CDRs to be generated for a single telephony communication, and for each CDR to contain different items of information about the telephony communication. When multiple CDRs are generated for the same telephony communication, it is difficult to correlate all the different CDRs to obtain the information needed to bill for the services, or to verify that charges from third party service providers are accurate.

### BRIEF DESCRIPTION OF THE DRAWINGS

FIG. 1 is a diagram of a communications environment including various elements which are associated with an Internet protocol (IP) telephony system operating in accordance with the invention;

FIG. 2 is a diagram of various elements of a processor that forms part of an IP telephony system;

FIG. 3 is a block diagram illustrating various logical elements that are involved in implementing a call between a calling party's telephony device and a called party's telephony device;

FIG. 4 is a flow chart illustrating steps of a first method embodying the invention;

FIG. 5 is a table illustrating CDR information that would be stored in a CDR database implemented according to one aspect of the invention; and

FIG. 6 is a flow chart illustrating steps of a second method embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

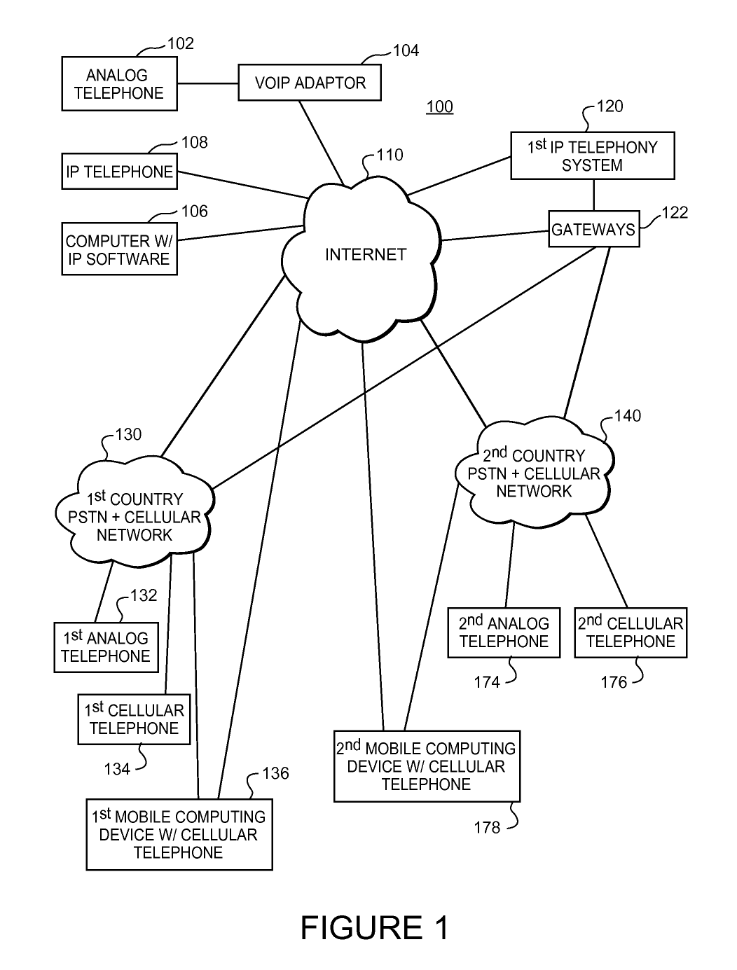

As illustrated in FIG. 1, a communications environment 100 is provided to facilitate IP based communications. A first IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to both a first publicly switched telephone network (PSTN)/cellular network 130 and a second PSTN/cellular 140 via one or more gateways 122, or via the Internet 110.

In the following description, no distinction is made between PSTNs and cellular service providers. For convenience, the following description will refer to PSTNs. However, this term is intended to include both traditional wireline-based PSTNs as well as cellular telephony service providers. This term is also intended to include telephony service providers that connect customers over data networks, such as cable television system interfaces and optical interfaces.

The gateway 122 allows users and devices that are connected to the first and second PSTNs 130, 140 to connect with users and devices that are reachable through the first IP telephony system 120, and vice versa. In some instances, the gateway 122 would be a part of the first IP telephony system 120. In other instances, the gateway 122 could be maintained by a third party.

Customers of the first IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a cellular telephone system to access the Internet 110.

Alternatively, a customer could utilize a normal analog telephone 102 which is connected to the Internet 110 via a telephone adapter 104. The telephone adapter 104 converts analog signals from the telephone 102 into data signals that pass over the Internet 110, and vice versa. Analog telephone devices include, but are not limited to, standard telephones and document imaging devices such as facsimile machines. A configuration using a telephone adapter 104 is common where multiple analog telephone devices 102 are located in a residence or business, and all of the analog telephone devices are connected to the same telephone adapter. With this configuration, all of the analog telephone devices share the same telephone number assigned to the telephone adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

A third party using the first analog telephone 132 which is connected to the first PSTN 130 may call a customer of the IP telephony system 120. In this instance, the call is initially connected from the first analog telephone 132 to the first PSTN 130, and then from the first PSTN 130, through the gateway 122 or the Internet 110 to the IP telephony system 120. The IP telephony system 120 then routes the call to the customer's IP telephony device (such as those described above). A third party using the first cellular telephone 134 could also place a call to an IP telephony system customer, and the connection would be established in a similar manner, although the first link would involve communications between the first cellular telephone 134 and a cellular telephone network. For purposes of this explanation, the cellular telephone network is considered part of the first PSTN 130.

In addition, mobile computing devices which include cellular telephone capabilities could also be used to place telephone calls to customers of the IP telephony system. The first mobile computing device 136, as illustrated in FIG. 1, might connect to the first PSTN 130 using its cellular telephone capabilities. However, such devices might also have the ability to connect wirelessly via some other means. For example, the mobile computing device 136 might communicate with a wireless data router to connect the first mobile computing device 136 directly to a data network, such as the Internet 110. In this instance, communications between the first mobile computing device 136 and other parties could be entirely carried by data communications which pass from the first mobile computing device 136 directly to a data network 110. Of course, alternate embodiments could utilize any other form of wired or wireless communications path to enable communications.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120. Further, in some instances a user could place a telephone call with the first analog telephone 132 or first cellular telephone 134 that is routed through the first PSTN 130 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system's network. Thus, the user is able place a long distance call using lower cost IP telephony service provided by the IP telephony system 120, rather than a higher cost service provided by the first PSTN 130.

A second PSTN 140 may be connected to a second analog telephone 174, a second cellular telephone 176 and a second mobile computing device 178. The IP telephony system can also route calls to and from its customers to telephony device reachable through the second PSTN 140.

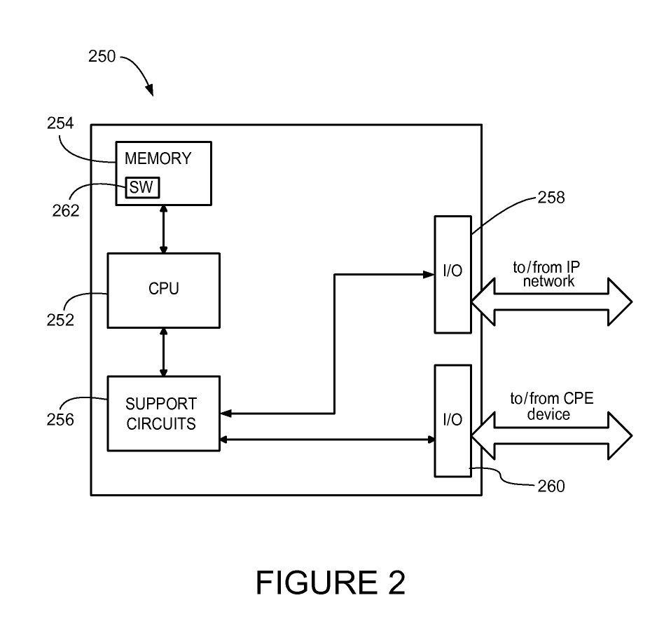

FIG. 2 illustrates elements of a computer processor 250 that can be used as part of the IP telephony systems 120 to accomplish various functions. The IP telephony systems 120 could include multiple processors 250 located at various locations in the system, along with their operating components and programming, each carrying out a specific or dedicated portion of the functions performed by the IP telephony system 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment and to service provider equipment, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to complete a telephone call. An IP telephony device could be an IP telephone, a computer running IP telephony software, a telephone adapter which is connected to an analog telephone, or some other type of device capable of communicating via data packets. An IP telephony device could also be a cellular telephone or a portable computing device that runs a software client that enables the device to act as an IP telephone. Thus, a single device might be capable of operating as both a cellular telephone and an IP telephone.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can then be run so that the Apple iPod Touch can interact with an IP telephony system to conduct a telephone call.

The following description will also refer to telephony communications and telephony activity. These terms are intended to encompass all types of telephone calls, regardless of whether all or a portion of the calls are carried in an analog or digital format. These terms are also intended to encompass data communications that are conveyed through a PSTN or VOIP telephony system, such as facsimile transmissions, text messages, SMS messages, MMS messages, video messages, and all other types of data communications sent by or received by a user. In other words, these terms are intended to encompass any communications whatsoever, in any format, which traverse all or a portion of a communications network or telephony network.

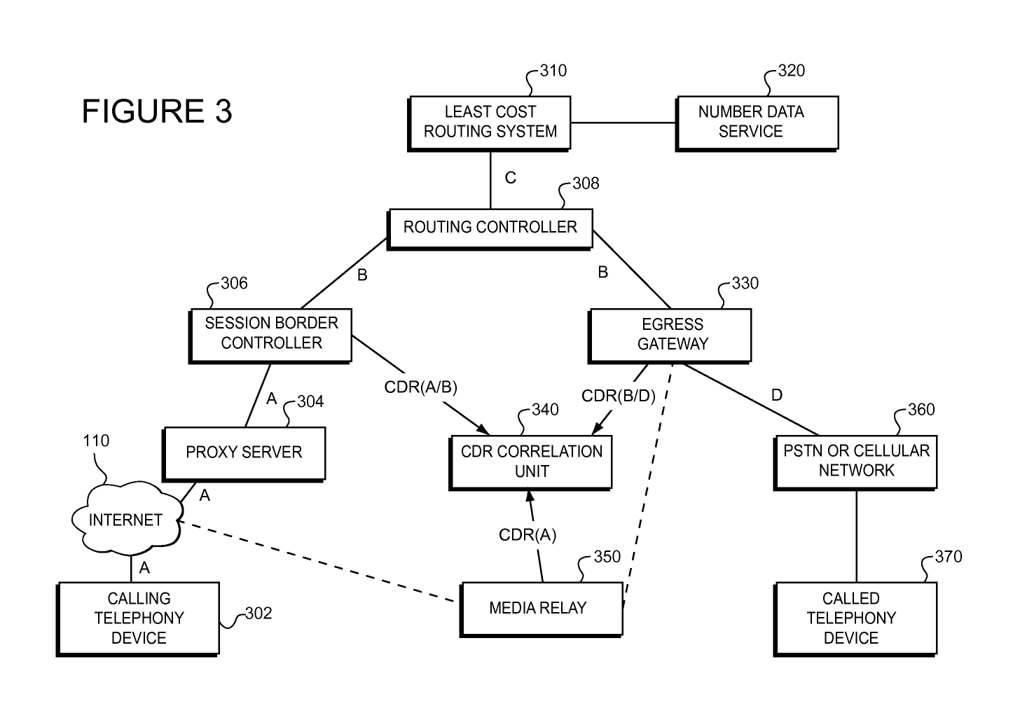

Methods of setting up telephony communications between a calling party and a called party will be described with reference to FIGS. 3-6. Part of those methods will include generating CDRs that include information about the telephony communications that can be used to bill for the communications, and which can also be used to verify that an IP system is being charged appropriately by third party service providers for their assistance in terminating telephony communications. Information in the CDRs is also used to monitor call quality, and for other diagnostic procedures. The methods will be used to explain how multiple CDRs that are generated for a single telephony communication can be correlated to yield the information needed to bill for the communications, to verify that third party charges are appropriate, and to monitor call quality.

FIG. 3 illustrates elements involved in setting up and carrying a telephony communication between a calling telephony device 302 and a called telephony device 370 in an IP telephony system such as the one described in FIG. 1. In FIG. 3, the calling telephony device 302 is coupled to the Internet 110, which would mean that the calling telephony device 302 could be an analog telephone that communicates through a VOIP adaptor, an IP telephone, a computer running IP software, or some other type of telephony device capable of conducting an IP telephone call. For example, the calling telephony device 302 might also be a mobile computing device running an IP telephony application, where the mobile computing device is capable of wireless data communications. In alternate embodiments, the calling telephony device 302 might be an analog telephone that communicates through a PSTN or a cellular telephone that communicates through a cellular telephony network.

Also, in the embodiment illustrated in FIG. 3, the called party telephony device 370 is coupled to a PSTN or cellular network 360. The called telephony device 370 could be an analog telephone connected to a PSTN or a cellular telephone connected to a cellular telephony network. In alternate embodiments the called telephony device 370 could be an analog telephone that communicates through a VOIP adaptor, an IP telephone, or a computer running IP software. The called telephony device 370 might also be a mobile computing device capable of wireless data communications that is running an IP telephony application. In those alternate embodiments, the PSTN or cellular network 360 would be replaced with a data network, such as the Internet 110.

In the following description, an audio telephone call is setup between the calling telephony device 302 and the called telephony device 370. However, the concepts and procedures described below are equally applicable to other forms of telephony communications, such as text messages, video messages, video calls and other forms of communications known to those skilled in the art.

In the embodiment illustrated in FIG. 3, when a calling party using the calling telephony device 302 wishes to setup a telephone call with a called party using the called telephony device 370, the calling telephony device 302 sends a call setup request through the Internet 110, or via some other access network, to a proxy server 304. The call setup request includes information identifying the called party and/or the called telephony device 370. The identifying information is typically in the form of a telephone number assigned to the called telephony device 370. However, other identifying information besides a telephone number assigned to the called telephony deice 370 could also be used.

This leg of the call setup request also includes a first call identification code represented by the letter “A” appearing in FIG. 3. The first call identification code A is assigned or generated by the calling telephony device 302.

The proxy server 304 contacts a session border controller 306 for assistance in setting up the call. The communication passing from the proxy server 304 to the session border controller 306 also includes the information identifying the called party and/or the called party telephony device 370, as well as the first call identification code A assigned by the calling telephony device 302.

The session border controller 306 contacts a routing controller 308 for help in identifying an appropriate egress gateway or proxy server that is capable of sending the call setup request on to the called telephony device 370. As a result of this action, the session border controller 306 assigns a second call identification code B to this leg of the telephony communication. Communications passing from the session border controller 306 to the routing controller 308 only refer to this second call identification code B.

The routing controller 308 contacts a least cost routing system 310 and asks for the identity of one or more egress gateways or proxy servers that could be used to complete the call to the called telephony device 370. The routing controller 308 assigns a third identification code “C” to this leg of the telephony communication and the communications passing back and forth between the routing controller 308 and the least cost routing system 310 use this third identification code C.

Optionally, the least cost routing system 310 consults with a data service 320. The data service 320 provides information about whether a telephone number of the called telephony device 370 is still controlled by the original assigning entity or whether that telephone number has been ported to a new telephony services provider. This information can be helpful in determining the least cost way to route the call.

The routing controller 308 uses the information provided by the least cost routing system 310 to send a message to an appropriate egress gateway or proxy server 330 capable of sending the call setup request on to the called telephony device 370. On this leg, the communications sent from the routing controller 308 to the egress gateway 330 include the second identification code B that was originally assigned by the session border controller 306.

The egress gateway 330 then uses information identifying the called party and/or the called telephony device 370 to contact a PSTN or cellular network 360 that is in communication with the called telephony device 370. At this leg of the call set up request, the egress gateway 330 assigns a fourth identification code “D” to the telephony communication. Finally, the PSTN or cellular network 360 contacts the called telephony device 370 to setup the call.

Assuming the call is answered, one or more of the logical devices involved in setting up the call can identify one or more media relays 350 through which data packets bearing the audio of the call can be routed. The dashed line appearing in FIG. 3 indicates the path traversed by data packets bearing the media of the call, whereas the solid lines in FIG. 3 illustrate the path traversed by the call setup signaling.

As noted above, when a call is setup in this fashion, multiple ones of the logical elements involved in setting up the call and carrying the media of the call may all generate their own CDRs containing data about the call. FIG. 3 illustrates that the session border controller 306 generates a first CDR that is sent to a CDR correlation unit 340. Also, the egress gateway 330 generates a second CDR that is also sent to the CDR correlation unit 340. Further, the media relay 350 generates a third CDR for the call that is sent to the CDR correlation unit 340.

If multiple media relays arranged in series are involved in transmitting the data packets bearing the media of the call, each media relay may generate its own CDR for the call. Further, a call might be switched from a first media relay to a second media relay partway through the call. In that instance, the first media relay would generate a first CDR for a first portion of the call and the second media relay would generate a second CDR for the second portion of the call.

The CDRs generated by all these logical elements include one or more of the identification codes generated by the logical elements handling the call. Since the logical elements refer to the same call by different identification codes, the identification codes are not the same in all of the CDRs. Moreover, each CDR may include both an ingress identification code and an egress identification code that correspond to ingress and egress “states” of one or more logical devices that create CDR's. For example, the session border controller 306 generates a CDR for the call which includes ingress identification code A, which was assigned by the calling telephony device 302, as well as egress identification code B that was assigned by the session border controller 306 itself. The egress gateway 330 generates a CDR that includes ingress identification code B forwarded from the routing controller 308, and egress identification code D that was assigned by the egress gateway 330 itself. Further, the media relay 350 generates a CDR that includes one or both of the identification code A assigned by the calling telephony device 302 and identification code D assigned by the egress gateway 330.

The CDR correlation unit 340 receives all of these CDRs, as well as many other CDRs generated by the same logical devices for different calls that are also being setup and carried by the same logical devices. Further, the CDR correlation unit also receives CDRs from other logical devices relating to other calls being setup and carried by those other logical devices. The CDR correlation unit must then determine which of the multiple received CDRs relate to the same call. Once that determination is made, it is possible to draw information from all of the multiple CDRs generated for the same call to accomplish billing functions, and to verify charges submitted by third party service providers. Also, the information contained in CDRs generated by the media relays may relate to call quality information. This information could be used by the system to determine how to route calls, and/or how to improve call quality.

The identification codes inserted into the CDRs can be used by the CDR correlation unit 340 to determine which of the CDRs relate to the same call. Although the CDRs may contain different identification codes, it is still possible to use this information to determine which CDRs are for a single call.

As noted above, the session border controller 306 generates a CDR for the call that includes ingress identification code A and egress identification code B. The egress gateway 330 generates a CDR with ingress identification code B and egress identification code D. By matching the egress identification code B in the CDR from the session border controller 306 with ingress identification code B in the CDR from the egress gateway 330, it is possible to determine that both CDRs relate to the same call. Likewise, by matching an identification code A or D in the CDR received from the media relay 350 with the identification codes in the CDRs received from the session border controller 306 and/or the egress gateway 330, it is possible to determine that the CDR received from the media relay 350 also relates to the same call.

In the short run, the identification codes generated by these logical elements will all be unique. However, over longer periods of time, the same identification codes may be re-used. For this reason, the time that the CDRs were generated may also be used to help match multiple CDRs that were generated for the same call.

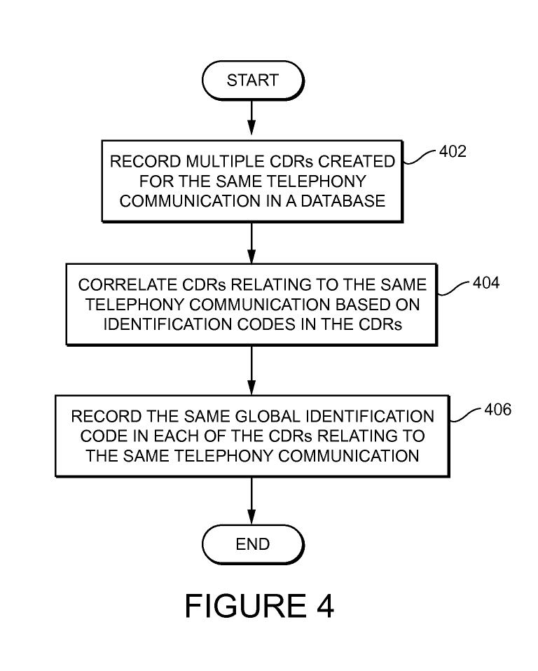

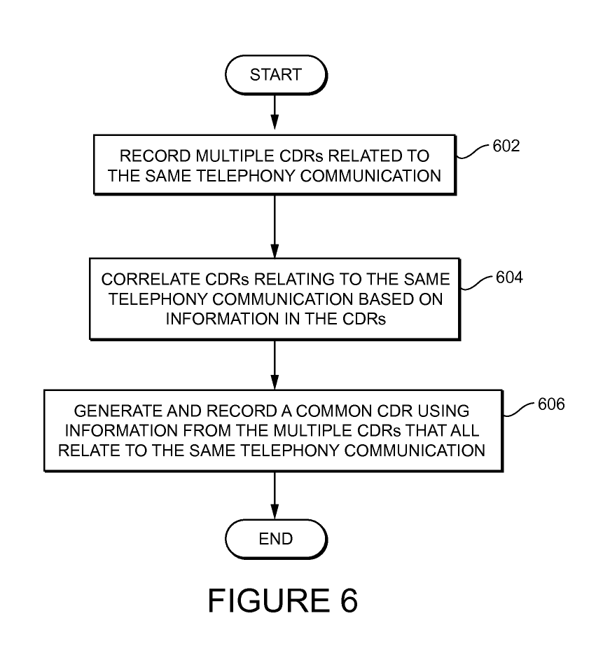

Once the CDRs relating to the same call have been identified by the CDR correlation unit, this information could be used in various ways to help facilitate the billing process, further routing decisions, call quality improvement efforts, and call troubleshooting. Two basic methods are illustrated in FIGS. 4 and 6.

In the foregoing description, an egress gateway 330 is used to connect the call to a PSTN or cellular service provider 360 that ultimately connects the call to the called telephony device 370. In alternate embodiments, the called telephony device 370 may be an IP telephony device that is capable of communicating with an IP telephony system via a data network. In those alternate embodiments, the egress gateway 330 is replaced with a proxy server that directly contacts the called telephony device 370 via a data network. Also, in those alternate embodiments, the called telephony device 370 would communicate directly with the media relay 350, via a data network, to communicate data packets bearing the media of the call. Data packets bearing the media of the call would not traverse the proxy server that replaces the egress gateway 330 in FIG. 3.

Also, in the foregoing description, the call is connected from the egress gateway 330 to the called telephony device 370 (via the PSTN or cellular network 360) on the first attempt to complete the call. It is also common for the first attempt to complete the call to fail. If the first attempt fails, in most cases additional attempts to complete the call will be made, either through the same egress gateway 330, or through an alternate egress gateway. Each call attempt will result in the generation of a CDR from the egress gateway attempting to complete the call. And, as explained above, each CDR generated by a call completion attempt will include an identification code that can be correlated to an identification code present in another CDR generated for the same call. Thus, the CDR correlation unit 340 is capable of identifying all of the CDRs generated by failed call completion attempts as belonging to the same call. The information provided by the CDRs from failed call completion attempts may be particularly helpful in troubleshooting and in identifying malfunctioning equipment.

Further, as described above, when the called telephony device is an IP telephony device communicating via a data network, the routing controller will attempt to complete the call through a proxy server, instead of the egress gateway 330 illustrated in FIG. 3. As explained above, it may be necessary to make multiple call completion attempts through multiple proxy servers before the call is completed to the called telephony device 370. Here again, each proxy server that attempts to complete the call will generate a CDR, and the CDR correlation unit 340 will be able to identify those CDRs as belonging to the same call using the identification codes in the CDRs.

The foregoing description identifies a few ways that various logical elements of an IP telephony system could operate to complete a call between a calling telephony device and a called telephony device. In alternate embodiments, calls could be completed in many other different ways, using different methods and using different logical devices. However, the generation of multiple CDRs for the same telephony communication is an issue for most of those alternate ways of connecting a call. The core concepts regarding how multiple CDRs are identified as being related to the same communication, and how the information from those multiple CDRs is gathered and used remains the same, regardless of the specific methods.

FIG. 4 illustrates steps of a first method embodying the invention. The method starts in step 402, where multiple CDRs all relating to the same telephony communication, but generated by different logical elements, are recorded in a database. In step 404, a determination of which CDRs relate to the same telephony communication is made using the identification codes appearing in the CDRs. Such a determination is made by, for example, the CDR correlation unit 340 described above. In step 406, additional information is written into each of the CDRs. Specifically, a global identification code is written into a global identification code field of all of the CDRs that share information associated with the same telephone communication.

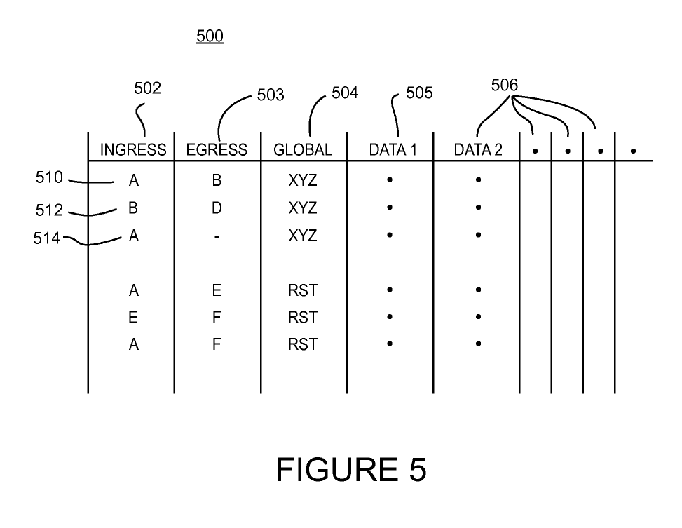

FIG. 5 illustrates a relational database structure 500 for the CDR database that could result from methods in accordance with the subject invention. However, this database structure is only an example. Many other database structures could also be used with departing from the invention. The first column 502 of the database structure 500 contains the ingress identification code of a particular CDR as defined by the ingress state of the logical device associated therewith. The second column 504 of the database structure 500 contains the egress identification code of a particular CDR as defined by the egress state of the logical device associated therewith. The third column 504 of the database structure 500 contains the global identification code assigned to two or more CDRs that are found to share common telephone communication information based on the correlation analysis as discussed above. The fourth column 505 of the database structure 500 contains data relevant to the specific leg of the call set up request and/or telephone communication associated therewith. The database structure may have additional data fields 506 as necessary to hold other information relevant to the communications activity.

Each row of the database structure 500 represents a different CDR. The first three CDRs (510,512 and 514, respectively) relate to the same telephony communication, and the same global identification code XYZ is written into a global identification code field of each of these CDRs. FIG. 5 also illustrates that the egress identification code B of the first CDR 510 matches the ingress identification code B of the second CDR 512. Likewise, the ingress identification code A of the third CDR 514 matches the ingress identification code of the first CDR 510.

The global identification code would uniquely identity a telephony communication. By querying the CDR database using a global identification code, one could easily identity all of the CDRs that were generated for a particular telephony communication. This makes it possible to collect information about the telephony communication from multiple ones of the CDRs for various purposes.

The global identification code could be assigned by the CDR correlation unit, or by some other logical entity. Further, the global identification code could correspond to one of the existing identification codes already assigned by one of the logical entities that originally produced by the CDRs. For example, the global identification code written into each of the CDRs for a telephony communication could be the first identification code A assigned by the calling telephony device.

By simply inserting a global identification code into the existing CDRs that have already been stored in the database, the remaining data in the CDRs will not be duplicated, which will save data storage resources. However, if it is necessary to acquire information from multiple CDRs for any purpose, the query necessary to locate all the data in the multiple CDRs may be somewhat more complicated.

FIG. 6 illustrates steps of another method embodying the invention. This method begins in step 602, when multiple CDRs relating to the same telephony communication are received. This action is accomplished, in one embodiment, by the CDR correlation unit 340 discussed above. In step 604, a determination of which CDRs relate to the same telephony communication is performed. This action is accomplished by correlation of the various identification codes in the CDR's as performed, by example in the CDR correlation unit 340. Then, in step 606, a new common CDR for the telephony communication that includes information pulled from two or more of the CDRs that were originally generated for the telephony communication is created. The common CDR could be assigned a new unique identification code, or one of the identification codes present in one of the original CDRs could be assigned to the common CDR to identify the telephony communication.

Although the method illustrated in FIG. 6 will result in the duplicate storage of certain data, all of the information needed for various purposes is consolidated in a single CDR. This can simplify the process of retrieving the data.

In some situations, the logical elements illustrated in FIG. 3 that generate the CDRs collected and analyzed by the CDR correlation unit 340 may all be part of an IP telephony system. In other instances, some of the logical elements may be part of some other system. For example, the egress gateway 330 that generates a CDR may be part of the IP telephony system that provides service to the calling telephony device 302, or it may be controlled by a third party that is paid by the IP telephony system to complete calls to called parties. Likewise, the media relay 350 may be part of the IP telephony system, or it may be controlled by a third party, and the IP telephony system may pay for use of the media relay 350. Regardless, the CDRs generated by those logical elements would still be received by the CDR correlation unit 340, or at least stored in a CDR database maintained by the IP telephony system.

In the description provided above, the routing controller 308 is used to help setup a call from the calling telephony device 302 to the called telephony device 370. The routing controller 308 may also generate a CDR for the call that includes identification code B, which was assigned by the session border controller 306 and/or identification code C, which is assigned by the routing controller 308 itself. This CDR may or may not be recorded in a CDR database or received by the CDR correlation unit 340. In some instances, the information contained in a CDR generated by the routing controller 308 may be useful for some purposes, and in other instances, this information may not be useful. Thus, in some situations, a CDR generated by the routing controller 308 may be ignored.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of correlating information relating to a telephony communication in an Internet protocol (IP) system, comprising:
recording a first call detail record (CDR) relating to a telephony communication that is produced by a first logical element in a database;
recording a second CDR relating to the telephony communication that is produced by a second logical element in the database; and
correlating the first CDR with the second CDR based on identification codes appearing in the first and second CDRs.

2. The method of claim 1, wherein the first and second CDRs each include an ingress identification code and an egress identification code, and wherein the correlating step comprises matching at least one of the ingress identification code and the egress identification code appearing in the first CDR with at least one of the ingress identification code and the egress identification code appearing in the second CDR.

3. The method of claim 2, wherein the correlating step comprises matching the egress identification code of one of the first and second CDRs to the ingress identification code of the other of the first and second CDRs.

4. The method of claim 2, wherein the first CDR is produced by a session border controller of the IP system, and wherein the second CDR is produced by an egress gateway.

5. The method of claim 1, further comprising recording a common global identification code in both the first CDR and the second CDR.

6. The method of claim 1, further comprising:
generating a common CDR for the telephony communication using information drawn from the first and second CDRs; and
recording the common CDR in a database.

7. The method of claim 1, further comprising recording a third CDR relating to the telephony communication that is produced by a third logical element in the database, and wherein the correlating step further comprises correlating the third CDR with the first and second CDRs based on an identification code appearing in the third CDR and an identification code appearing in at least one of the first and second CDRs.

8. The method of claim 7, wherein the first and second CDRs each include an ingress identification code and an egress identification code, and wherein the correlating step comprises matching an identification code in the third CDR to at least one of the ingress identification code and the egress identification code of at least one of the first and second CDRs.

9. The method of claim 8, wherein the third logical element of the IP system is a media relay and wherein the third CDR includes call quality information.

10. The method of claim 7, further comprising recording a common global identification code in the first, second and third CDRs.

11. The method of claim 7, further comprising:
generating a common CDR for the telephony communication using information drawn from the first, second and third CDRs; and
recording the common CDR in a database.

12. A method of correlating a plurality of call detail records (CDRs) relating to a single telephony communication in an Internet protocol (IP) system, comprising:
receiving a first CDR that contains information about the telephony communication from a first logical element;
receiving a second CDR that contains information about the telephony communication from a second logical element; and
correlating information contained in the first and second CDRs to determine that the first and second CDRs relate to the same telephony communication.

13. The method of claim 12, wherein each of the first and second CDRs include an ingress identification code and an egress identification code, and wherein the determining step comprises matching at least one of the ingress identification code and the egress identification code of the first CDR to at least one of the ingress identification code and the egress identification code of the second CDR to determine that the first and second CDRs relate to the same telephony communication.

14. The method of claim 13, wherein the correlating step is also based on a time that the first and second CDRs were created.

15. The method of claim 13, further comprising recording a global identification code into each of the first and second CDRs.

16. The method of claim 12, further comprising creating a common CDR for the telephony communication using information contained in the first and second CDRs.

17. The method of claim 12, further comprising receiving a third CDR that contains information about the telephony communication from a third logical element, and wherein the correlating step further comprises correlating information contained in at least one of the first and second CDRs to information contained in the third CDR to determine that the third CDR relates to the same telephony communication as the first and second CDRs.

18. The method of claim 17, further comprising recording a global identification code into each of the first, second and third CDRs.

19. The method of claim 17, further comprising creating a common CDR for the telephony communication using information contained in the first, second and third CDRs.

20. A system for correlating a plurality of call detail records (CDRs) relating to a single telephony communication in an Internet protocol (IP) system, comprising:
means for receiving a first CDR that contains information about the telephony communication from a first logical element;
means for receiving a second CDR that contains information about the telephony communication from a second logical element; and
means for correlating information contained in the first and second CDRs to determine that the first and second CDRs relate to the same telephony communication.

21. A system for correlating a plurality of call detail records (CDRs) relating to a single telephony communication in an Internet protocol (IP) system, comprising:
a first receiving unit that receives a first CDR that contains information about the telephony communication from a first logical element and a second CDR that contains information about the telephony communication from a second logical element; and
a CDR correlation unit that correlates information contained in the first and second CDRs to determine that the first and second CDRs relate to the same telephony communication.

22. The system of claim 21, wherein each of the first and second CDRs include an ingress identification code and an egress identification code, and wherein the CDR correlation unit matches at least one of the ingress identification code and the egress identification code of the first CDR to at least one of the ingress identification code and the egress identification code of the second CDR to determine that the first and second CDRs relate to the same telephony communication.

23. The system of claim 22, wherein the CDR correlation unit also uses information relating to a time that the first and second CDRs were created to determine that the first and second CDRs relate to the same telephony communication.

24. The system of claim 22, wherein the CDR correlation unit causes a global identification code to be recorded into each of the first and second CDRs.

25. The system of claim 21, wherein the CDR correlation unit causes a common CDR to be created for the telephony communication using information contained in the first and second CDRs.

26. The system of claim 21, wherein the receiving unit also receives a third CDR that contains information about the telephony communication from a third logical element, and wherein the CDR correlation unit correlates information contained in at least one of the first and second CDRs to information contained in the third CDR to determine that the third CDR relates to the same telephony communication as the first and second CDRs.

27. The system of claim 26, wherein the CDR correlation unit causes a global identification code to be recorded into each of the first, second and third CDRs.

28. The system of claim 26, further wherein the CDR correlation unit causes a common CDR to be created for the telephony communication using information contained in the first, second and third CDRs.
